(19) United States
(12) Patent Application Publication
(10) Pub. No.: US 2024/0399291 A1
(43) Pub. Date: Dec. 5, 2024

(54) METHODS FOR TREATING GASEOUS EFFLUENT

(71) Applicant: Enerflex Ltd., Calgary (CA)

(72) Inventor: Gabriel M. GREEN, Houston, TX (US)

(21) Appl. No.: 18/667,542

(22) Filed: May 17, 2024

Related U.S. Application Data
(60) Provisional application No. 63/505,145, filed on May 31, 2023.

(51) Int. Cl. B01D 53/14

(52) U.S. Cl. CPC B01D 53/1456; B01D 53/1418; B01D 53/1431; B01D 2252/204

(57) ABSTRACT

There is provided a method of treating a gaseous effluent material that includes pollutant material, comprising establishing a gaseous effluent derivative material flow, that is derived from the gaseous effluent material and is motivated by a prime mover. The processing of the gaseous effluent derivative material flow is effected via a process configuration that is disposed downstream of the prime mover. The pollutant is absorbed by an absorption-effective material via the process configuration Heat is recovered via the process configuration for effecting desorption of the pollutant material from the absorption-effective material.

### CROSS REFERENCE TO RELATED APPLICATIONS

This application claims priority from U.S. Provisional Application No. 63/505,145, filed May 31, 2023, entitled METHODS FOR TREATING GASEOUS EFFLUENT, the contents of which are incorporated by reference herein.

### FIELD

This relates to treating gaseous effluent for preventing undesirable emissions to the atmosphere.

### BACKGROUND

Existing technologies for treating gaseous effluent, with a view to sequestering pollutants such as gaseous carbon dioxide, are challenging to implement. Such technologies are often energy and capital intensive.

### SUMMARY

In one aspect, there is provided a method of treating a gaseous effluent material that includes pollutant material, comprising:
within a process vessel, processing a gaseous effluent-derived material, that is derived from the gaseous effluent material, with effect that at least a pollutant material-lean gaseous material product is produced;
wherein:
   the processing of the gaseous effluent-derived material includes:
within a direct contact cooling zone, defined within the process vessel, contacting an absorption-unsuitable gaseous material with liquid cooling material, with effect that at least a cooled gaseous material is produced, wherein the absorption-unsuitable gaseous material is derived from the gaseous effluent material; and
within an absorption zone, defined within the process vessel, contacting an absorption-ready gaseous material, derived from the cooled gaseous material, with an absorption-effective material, with effect that at least a portion of the pollutant material, of the absorption-ready gaseous material, is absorbed by the absorption-effective material, such that at least a pollutant material-depleted gaseous material and a loaded absorbent-comprising material are produced;
and
the pollutant material-lean gaseous material product is derived from the pollutant material-depleted gaseous material.

In another aspect, there is provided a method of treating a gaseous effluent material that includes pollutant material, comprising:
establishing a gaseous effluent derivative material flow, that is derived from the gaseous effluent material and is motivated by a prime mover;
processing the gaseous effluent derivative material flow via a process configuration that is disposed downstream of the prime mover, wherein:
   the processing of the gaseous effluent material flow is with effect that at least a pollutant material-lean gaseous product and a pollutant material-rich absorbent-comprising material product are produced;
   the processing of the gaseous effluent derivative material flow includes:
      cooling an absorption-resisting gaseous material, derived from the gaseous effluent material, with effect that a cooled gaseous effluent derivative material is produced; and
      contacting an absorption-ready gaseous material, that is derived from the cooled gaseous effluent derivative material, with an absorption-effective material, with effect that at least a portion of the pollutant material, of the absorption-ready gaseous material, is absorbed by the absorption-effective material, such that at least a pollutant material-depleted gaseous material and a loaded absorbent-comprising material are produced;
   the pollutant material-lean gaseous product stream is derived from the pollutant material-depleted gaseous material;
   and
   the pollutant material-rich absorbent-comprising material product is derived from the loaded absorbent-comprising material;
and
heating the pollutant material-rich absorbent-comprising material product, with effect that a pollutant material-rich gaseous material is released from the pollutant material-rich absorbent-comprising material;
wherein:
   the cooling, of the absorption-resisting gaseous material, co-operates with the heating of the pollutant material-rich absorbent-comprising material product, such that the heating, of the pollutant material-rich absorbent-comprising material product, is effected by energy recovered from the cooling of the hot gaseous effluent material.

In another aspect, there is provided a method of treating gaseous effluent material that includes pollutant material, comprising:
via at least a prime mover, establishing a gaseous effluent material flow that is derived from the gaseous effluent material; and
processing the gaseous effluent material flow via a process configuration with effect that at least a pollutant material-lean gaseous material product is produced, wherein:
   the processing of the gaseous effluent material flow includes, within an absorption zone of the process configuration, contacting an absorption-ready gaseous material flow, that is derived from the gaseous effluent material, with an absorption-effective material with effect that at least a portion of the pollutant material, of the absorption-ready gaseous material, is absorbed by the absorption-effective material, such that at least a pollutant material-depleted gaseous material is produced;
wherein:
   the pollutant material-lean gaseous material product is derived from the pollutant material-depleted gaseous material; and
the absorption zone is disposed upstream of the prime mover.

### BRIEF DESCRIPTION OF DRAWINGS

The preferred embodiments will now be described with the following accompanying drawings:

FIG. 1 is a schematic illustration of an embodiment of a system in which is practised an embodiment of the process of the present disclosure; and

FIG. 2 is a schematic illustration of another embodiment of a system in which is practised an embodiment of the process of the present disclosure

### DETAILED DESCRIPTION

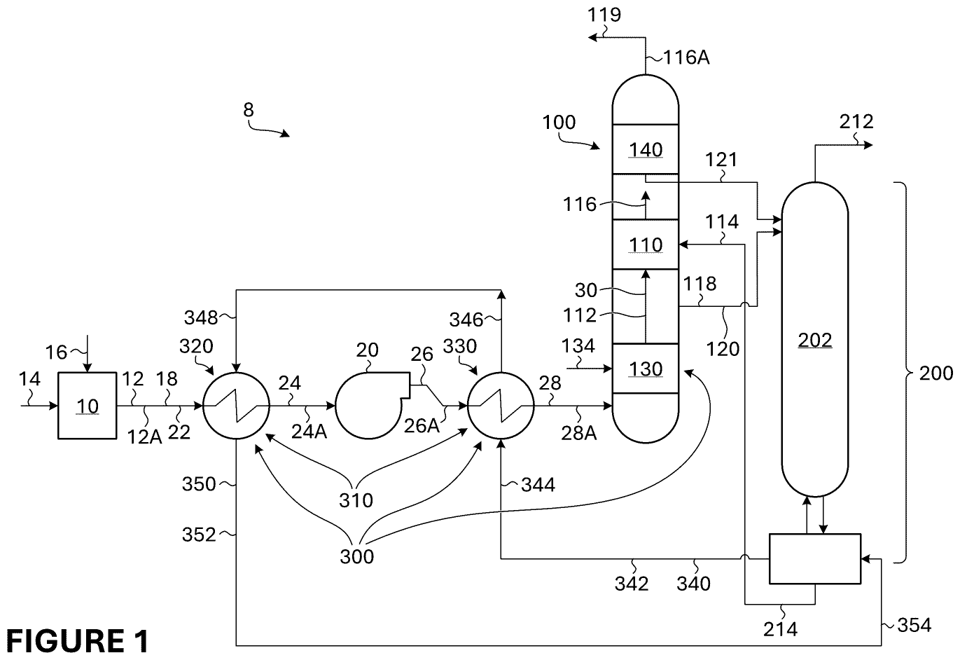

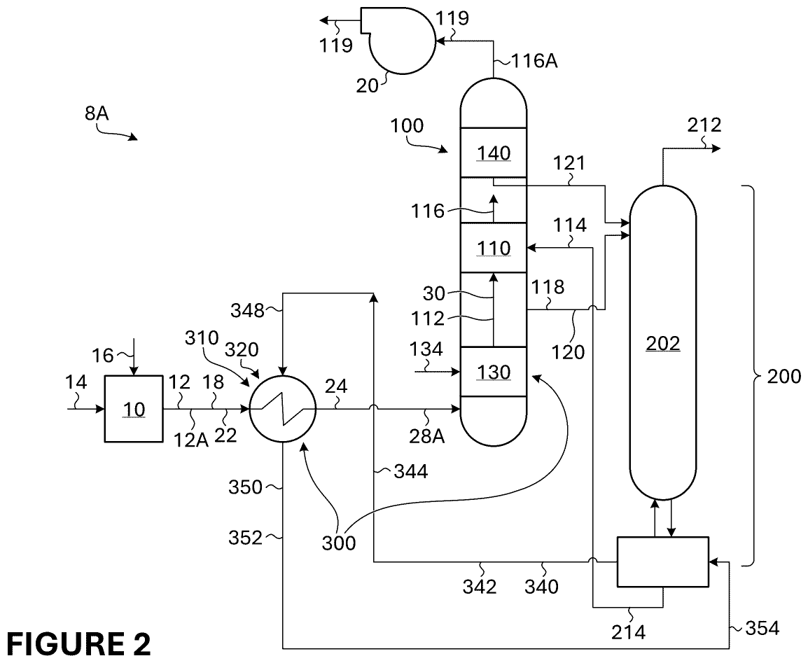

Referring to FIGS. 1 and 2, there is provided a system 8 for implementing a method of treating a gaseous material effluent 12 that includes a pollutant material. The treating includes processing of a gaseous effluent derivative material flow 12A that is motivated by a primer mover 20 (e.g. a blower). The gaseous effluent derivative material, of the flow 12A, is derived from the gaseous effluent material 12, and, in some embodiments, for example, is the gaseous effluent material 12.

The processing includes, within an absorption zone 110, contacting an absorption-ready gaseous material 112, derived from the gaseous material effluent 12 (in some embodiments, for example, the absorption-ready gaseous material 112 is the gaseous material effluent), with an absorption-effective material 114, with effect that an absorbed pollutant material (defined by at least a portion of the pollutant material of the absorption-ready gaseous material 112) is absorbed by the absorption-effective material 114, with effect that at least a pollutant material-depleted gaseous material 116 and a loaded absorbent-comprising material 118 are produced. In some embodiments, for example, the absorption zone is disposed within a gaseous effluent treating vessel 100, such as, for example, a column.

In some embodiments, for example, the source of the gaseous effluent material 12 includes an industrial source. In some embodiments, for example, the source of the gaseous effluent material 12 includes an atmospheric source, such as, for example, atmospheric air. In some embodiments for example, the source of gaseous effluent material 12 derives from a combination of sources.

In some embodiments, for example, the pollutant material includes acid gas material that is defined by at least one acid gas. The term “acid gas”, as used herein, refers to a chemical compound that is a gas at ambient conditions and is considered a Lewis Acid. Examples of an acid gas include CO₂, CO, COS, H₂S, SO₂, NO, N₂O, mercaptans, H₂O, O₂, H₂, N₂, and Cl₂. In this respect, in some embodiments, for example, the pollutant material includes carbon dioxide (CO₂). in some embodiments, for example, the pollutant material is carbon dioxide. In some embodiments, for example, the gaseous effluent material 12 includes from two (2) volume % carbon dioxide, based on the total volume of the gaseous effluent material 12, to 50 volume % carbon dioxide, based on the total volume of the gaseous effluent material 12. In some of these embodiments, for example, the gaseous effluent material 12 includes from five (5) volume % carbon dioxide, based on the total volume of the gaseous effluent material 12, to 15 volume % carbon dioxide, based on the total volume of the gaseous effluent material 12.

In some embodiments, for example, the source of the gaseous effluent material 12 is a combustion zone 10. In some embodiments, for example, the gaseous effluent material 12 is produced in response to contacting of a fuel 14 and an oxidant 16 within the combustion zone 10. In this respect, in some embodiments, for example, the process further includes combusting a fuel 14, with effect that the gaseous effluent material 12 is produced, such that the gaseous effluent material 12 is produced via the combusting. In some embodiments, for example, the fuel 14 includes hydrocarbon material, and the hydrocarbon material includes at least one hydrocarbon. Suitable sources of hydrocarbons include natural gas, propane, kerosene, diesel, petrol, charcoal, coal, wood, or any combination thereof. In some embodiments, for example, the oxidant include gaseous diatomic oxygen. In some embodiments, for example, the oxidant is derived from an oxidant-comprising gaseous material. In some embodiments, for example, the oxidant-comprising gaseous material is atmospheric air.

In some embodiments, for example, the absorption-effective material 114 is a liquid material, such that the loaded absorbent-comprising material 118 is also a liquid material. In some embodiments, for example, the liquid material is an aqueous liquid material, such that the absorption-effective material 114 is an aqueous liquid material, and such that the loaded absorbent-comprising material 118 is also an aqueous liquid material. In some embodiments, for example, the absorption-effective material 114 is an amine-based absorbent material. In some embodiments, for example, the amine-based absorbent material includes at least one amine. In some embodiments, for example, each one of the at least one amine, independently is a primary amine or a secondary amine. Suitable amine-based absorbents include diethanolamine (DEA), monoethanolamine (MEA), methyldiethanolamine (MDEA), diisopropanolamine (DIPA), and aminoethoxyethanol (diglycolamine) (DGA). In some embodiments, for example, the amine-based absorbent material is a liquid material, such as, for example, an aqueous liquid material.

In some embodiments, for example, the absorption of the absorbed pollutant material is with effect that at least a portion of the absorbed pollutant material is physically absorbed within the loaded absorbent-comprising material 118. In those embodiments where the pollutant material includes carbon dioxide and the absorbent-effective material 114 includes an aqueous material, in some of these embodiments, for example, the absorption is with effect that at least a portion of the absorbed pollutant material is physically absorbed within the aqueous material.

In some embodiments, for example, the absorption of the absorbed pollutant material is with effect that at least a portion of the absorbed pollutant material is converted to a derivative pollutant material, such that the loaded absorbent-comprising material 118 includes the derivative pollutant material. In some of these embodiments, for example, the derivative pollutant material is dissolved within the loaded absorbent-comprising material 118. In those embodiments where the pollutant material includes carbon dioxide and the absorption-effective material 114 includes an amine-based absorbent, in some of these embodiments, for example, the derivative pollutant material is a carbon dioxide derivative material, and the carbon dioxide derivative material is at least one dissolved amine salt.

The volumetric concentration of the pollutant material, within the absorption-ready gaseous material 112, exceeds the volumetric concentration of the pollutant material within the pollutant material-depleted gaseous material 116. As a corollary, the volumetric concentration of pollutant material, within the loaded absorbent-comprising material 118, exceeds the volumetric concentration of the pollutant material within the absorption-effective material 114. In some embodiments, for example, the ratio of the volumetric concentration of the pollutant material, within the pollutant material-depleted gaseous material 116, to the volumetric concentration of the pollutant material, within the absorption-ready gaseous material 112, is less than 0.5, such as, for example, less than 0.4 In some embodiments, for example, the ratio of the volumetric concentration of the pollutant material, within the pollutant material-depleted gaseous material 116, to the volumetric concentration of the pollutant material, within the absorption-ready gaseous material 112, is from 0.3 to 0.5.

In some embodiments, for example, the absorption zone 110 is occupied by contacting-effective porous solid media for encouraging the contacting of the absorption-ready gaseous material 112 with the absorption-effective material 114. Suitable examples of the contacting-effective media include moveable valve trays, non-moveable valve trays, sieve trays, bubble cap trays, random packing, and structured packing.

In some embodiments, for example, the absorption zone 110 is disposed at a sufficiently low temperature such that the contacting of the absorption-ready gaseous material 112 with the absorption-effective material 114 in the absorption zone 110 is effective for effecting the absorption of the absorbed pollutant material. In some embodiments, for example, if the temperature is excessively high, the contacting is ineffective for effecting the absorption, or is, at least, ineffective for effecting adequate absorption. In this respect, in some embodiments, for example, the temperature of the absorption zone 110 is below 250 degrees Fahrenheit, such as, for example, below 200 degrees Fahrenheit.

In some embodiments, for example, the temperature of the gaseous effluent material 12 is excessively high, such that, without intervention, the absorption-ready gaseous material 112, which derives from the gaseous effluent material 12, would also be excessively high for effecting the adequate absorption of the absorbed pollutant material. In this respect, the processing of a gaseous effluent derivative material flow 12A includes a cooling of an absorption-resisting gaseous material 18, derived from the gaseous effluent material 12 (and, in some embodiments, for example, the absorption-resisting gaseous material 18 is the gaseous effluent material 12), via a cooling system 300, with effect that a cooled gaseous effluent derivative material 20 is produced. The absorption-ready gaseous material 112 is derived from the cooled gaseous effluent derivative material 20, and, in some embodiments, is the cooled gaseous effluent derivative material 20. The cooling is with effect that the temperature of the absorption-ready gaseous material 112 is sufficiently low for effecting the absorption of the absorbed pollutant material.

In some embodiments, for example, the temperature of the absorption-resisting gaseous material 18, which is derived from the gaseous effluent material 12, is at least 500 degrees Fahrenheit. In some embodiments, for example, the temperature of the absorption-resisting gaseous material 18 is less than 1,400 degrees Fahrenheit. In some embodiments, for example, the temperature of the absorption-resisting gaseous material 18 is within a range, and the range is from 800 degrees Fahrenheit to 1,200 degrees Fahrenheit To effect the adequate absorption of the absorbed pollutant material, in some embodiments, for example, the cooling is with effect that the temperature of the absorption-ready gaseous material 112 is below 125 degrees Fahrenheit. In some embodiments, for example, the cooling is with effect that the temperature of the absorption-ready gaseous material 112 is from 70 degrees Fahrenheit to 125 degrees Fahrenheit

In some embodiments, for example, the processing of a gaseous lean gaseous material product 119. The pollutant material-lean gaseous material product 119 is derived from the pollutant material-depleted gaseous material 116. In some embodiments, for example, the pollutant material-lean gaseous material product 119 is the pollutant material-depleted gaseous material 116. In some embodiments, for example, the recovering includes discharging the pollutant material-lean gaseous material product 119 from the gaseous effluent treating vessel 100 as a pollutant material-lean gaseous material product stream. In some embodiments, for example, the discharging of the pollutant material-lean gaseous material product stream is effected via respective process piping.

In some embodiments, for example, some of the absorption-effective material 114 becomes entrained within the pollutant material-depleted gaseous material 116 such that, potentially, the absorption-effective material 114 is recovered as part of the pollutant material-lean gaseous material product 119. To mitigate this potential loss of the absorption-effective material 114, the pollutant material-depleted gaseous material 116 is contacted with a recirculating liquid aqueous water wash material, within a water wash zone 140, with effect that a water-washed gaseous material 116A, that is depleted in the absorption-effective material relative to the pollutant material-depleted gaseous material 116, is produced. The recovered pollutant material-lean gaseous material product 119 is derived from the water-washed gaseous material 116A (and, in some embodiments, for example, the recovered pollutant material-lean gaseous material product 119 is the water-washed gaseous material 116A). A portion of the liquid aqueous water wash material is bled from the recirculating liquid aqueous water wash material as bleed 121, for recovery of the absorption-effective material 114 that has been removed from the pollutant material-depleted gaseous material 116. In some embodiments, for example, the liquid aqueous wash water material is part of the same recirculation circuit as the liquid cooling material 134 used in the direct contact cooling zone 130.

In some embodiments, for example, the water wash zone 140 is disposed within the process vessel 100.

In some embodiments, for example, the processing of a gaseous rich material product 120. The pollutant material-rich material product 120 is derived from the loaded absorbent-comprising material 118. In some embodiments, for example, the pollutant material-rich material product 120 is the loaded absorbent-comprising material 118. In those embodiments where the loaded absorbent-comprising material 118 is a liquid material, in some of these embodiments, for example, the pollutant material-rich material product 120 is also a liquid material. In some embodiments, for example, the recovering includes discharging the pollutant material-rich material product 120 from the gaseous effluent treating vessel 100 as a pollutant material-rich material product stream. In some embodiments, for example, the discharging of the pollutant material-rich material product stream is effected via respective process piping.

In this respect, the recovering of the pollutant material-lean gaseous material product 119 is effected independently of the recovering of the pollutant material-rich material product 120.

In some embodiments, for example, pollutant material is released (e.g. desorbed) from the pollutant material-rich absorbent-comprising material product 120 for obtaining the pollutant material in suitably concentrated form for enabling its efficient storage in a suitable storage configuration (e.g. container or reservoir within a subterranean formation), or enabling its transportation to a distribution system. In this respect, in those embodiments where the pollutant material-rich absorbent-comprising material product 120 is a liquid material, in some of these embodiments, for example, the pollutant material-rich absorbent-comprising material product 120 is heated with effect that a pollutant material-rich gaseous material 212 is released from the pollutant material-rich absorbent-comprising material product 120, and with effect that a pollutant material-depleted absorbent-comprising liquid material 214 is obtained. In some embodiments, for example, the releasing of the pollutant material is effected via steam stripping within a desortion vessel 202 of a desorption system 200.

In some embodiments, for example, the pollutant material-depleted absorbent-comprising liquid material 214 is recycled such that the absorption-effective material 114 includes the pollutant material-depleted absorbent-comprising liquid material 214 (and, in some embodiments, for example, the absorption-effective material 114 is the pollutant material-depleted absorbent-comprising liquid material 214).

In some embodiments, for example, the bleed 121 is supplied to the desorber vessel 202 via process piping, and combined with the pollutant material-rich absorbent-comprising material product 120 within the desorber vessel 202, with effect that the absorption-effective material 114, of the bleed 121, is recovered within the pollutant material-depleted absorbent-comprising liquid material 214.

In some embodiments, for example, a pollutant-concentrated material is recovered from the pollutant material-rich gaseous material 212. In some embodiments, for example, the pollutant-concentrated material is recovered from the pollutant material-rich gaseous material 212 in the form of a liquid material via liquefying in response to cooling of the pollutant material-rich gaseous material 212. In some embodiments, for example, the pollutant-concentrated material is recovered from the pollutant material-rich gaseous material 212 in the form of a liquid material via liquefying in response to compression of the pollutant material-rich gaseous material 212

In some embodiments, for example, the cooling of the absorption-resisting gaseous material 18 includes cooling effected via a waste heat recovery system 310 of the cooling system 300. In this respect, in some embodiments, for example, the cooling, of the absorption-resisting gaseous material 18, co-operates with the heating of the pollutant material-rich absorbent-comprising material product 120, such that the heating, of the pollutant material-rich absorbent-comprising material product 120, is effected by energy recovered from the cooling of the absorption-resisting gaseous material 18.

In some embodiments, for example, the heating of the pollutant material-rich absorbent-comprising material product 120 is effected via a hot desorption-stimulating heating fluid 354. Suitable heating fluids 354 include water, steam, glycols, and thermal oils. The cooling of the absorption-resisting gaseous material 18 is effected by a cooler desorption-stimulating heating fluid 342 and, synergistically, heating of the cooler desorption-stimulating heating fluid 342, is effected by the absorption-resisting gaseous material 18 in response to emplacement of the cooler desorption-stimulating heating fluid 342 in heat transfer communication with the absorption-resisting gaseous material 18, with effect that a gaseous effluent-heated desorption-stimulating heating fluid 352, from which the hot desorption-stimulating heating fluid 354 derives, is obtained (and, in some embodiments, for example, the hot desorption-stimulating heating fluid 354 is the gaseous effluent-heated desorption-stimulating heating fluid 352). In this respect, the waste heat recovery system 310 establishes heat transfer communication (e.g. an indirect heat transfer communication) between the cooler desorption-stimulating heating fluid 342 and the absorption-resisting gaseous material 18 for effecting heating of the cooler desorption-stimulating heating fluid 342, with effect that the gaseous effluent-heated desorption-stimulating heating fluid 352 is produced. The heating of the pollutant material-rich absorbent-comprising material product 120 by the hot desorption-stimulating heating fluid 354 (which derives from the gaseous effluent-heated desorption-stimulating heating fluid 352) is with effect that the hot desorption-stimulating heating fluid 354 is cooled such that a recovered post-desorption heating fluid 340 is produced.

Referring to FIG. 1, in some embodiments, for example, the prime mover 20 is emplaced upstream of the gaseous effluent treating vessel 100 within which the absorption zone 110 is defined. In such embodiments, for example, the waste heat recovery system 310, of the cooling system 300, includes a suction-side waste heat recovery subsystem 320, disposed upstream of the prime mover 20, and a discharge-side waste heat recovery subsystem 330, disposed downstream of the prime mover 20.

In some embodiments, for example, the cooling of the absorption-resisting gaseous material 18 includes a cooling of a hot gaseous material supply 22 that derives from the gaseous effluent material 12 (and, in some embodiments, for example, the hot gaseous material supply 22 is the gaseous effluent material 12). In some embodiments, for example, the temperature of the hot gaseous material supply 22, which is derived from the gaseous effluent material 12, is at least 500 degrees Fahrenheit. In some embodiments, for example, the temperature of the hot gaseous material supply 22 is less than 1,400 degrees Fahrenheit. In some embodiments, for example, the temperature of the hot gaseous material supply 22 is within a range, and the range is from 800 degrees Fahrenheit to 1,200 degrees Fahrenheit The cooling is with effect that a cooler gaseous material supply 24 is produced, such that the gaseous effluent material input 24A derives from the cooler gaseous material supply 24 (and, in some embodiments, for example, the gaseous effluent material input 24A is the cooler gaseous material supply 24). The temperature of the cooler gaseous material supply 24 is less than the temperature of the hot gaseous material supply 22. In this respect, in some embodiments, for example, the cooling, of the hot gaseous material supply 22, is with effect that the temperature of the cooler gaseous material supply 24 is lower than the temperature of the hot gaseous material supply 22 by at least one degree Fahrenheit, such as, for example, at least 100 degrees Fahrenheit, such as, for example, at least 200 degrees Fahrenheit, such as, for example, at least 300 degrees Fahrenheit, such as, for example, at least 400 degrees Fahrenheit. In some of these embodiments, for example, the temperature of the cooler gaseous material supply 24 is lower than the temperature of the hot gaseous material supply 22 by less than 1000 degrees Fahrenheit. In some embodiments, for example, the temperature of the cooler gaseous material supply 24 is below 500 degrees Fahrenheit. In some embodiments, for example, the temperature of the cooler gaseous material supply 24 is at least 275 degrees Fahrenheit. In some embodiments, for example, the temperature of the cooler gaseous material supply 24 is within a range, and the range is from 350 degrees Fahrenheit to 400 degrees Fahrenheit.

The processing of a gaseous effluent derivative material flow 12A includes supplying the gaseous effluent material input 24A, derived from the cooler gaseous material supply 24, to the prime mover 20. In some embodiments, for example, the cooling of the hot gaseous material supply 22 is with effect that the temperature of the gaseous effluent material input 24A is sufficiently low such that the temperature of the gaseous effluent material input 24A is insufficient to adversely affect operation of the prime mover 20 (e.g. a blower). In this respect, in some embodiments, for example, the temperature of the gaseous effluent material input 24A is below 500 degrees Fahrenheit. In some embodiments, for example, the temperature of the gaseous effluent material input 24A is at least 275 degrees Fahrenheit. In some embodiments, for example, the temperature of the gaseous effluent material input 24A is within a range, and the range is from 350 degrees Fahrenheit to 400 degrees Fahrenheit.

In some embodiments, for example, the cooling of the hot gaseous material supply 22 is effected via the suction sidewaste heat recovery subsystem 320. In some embodiments, for example, the cooling of the hot gaseous material supply 22, via the suction side waste heat recovery (“WHR”) system 320, is effected in response to emplacement of the hot gaseous material supply 22 in heat transfer communication (e.g. indirect heat transfer communication) with a suction side cool WHR cooling fluid 348, that is derived from a discharge side heated WHR cooling fluid 346 (as further described below), such that, correspondingly, the suction side cool WHR cooling fluid 348 is heated, and with effect that a suction side heated WHR cooling fluid 350 is produced, such that the hot desorption-stimulating heating fluid 354 derives from the suction side heated WHR cooling fluid 350. In this respect, the cooling of the absorption-resisting gaseous material 18, by the cooler desorption-stimulating heating fluid 342, includes the cooling of the hot gaseous material supply 22 by the suction side cool WHR cooling fluid 348. Also in this respect, the temperature of the hot gaseous material supply 22 is greater than the temperature of the suction side cool WHR cooling fluid 348. In some embodiments, for example, the temperature of the hot gaseous material supply 22 exceeds the temperature of the suction side cool WHR cooling fluid 348 by at least one degree Fahrenheit, such as, for example, by a temperature differential that is at least 100 degrees Fahrenheit, such as, for example, by a temperature differential that is at least 300 degrees Fahrenheit. In some embodiments, for example, the suction side heated WHR cooling fluid 350, obtained as a result of the heating of the suction side cool WHR cooling fluid 348, has a temperature that exceeds the temperature of the suction side cool WHR cooling fluid 348 by at least 25 degrees Fahrenheit, such as, for example, at least 50 degrees Fahrenheit.

While the gaseous effluent derivative material flow 12A is being motivated by the prime mover 20, heat is transferred from the prime mover 20 to the gaseous effluent material input 24A, with a resulting increase in temperature of a gaseous effluent material output 26, being produced and discharged from the prime mover 20, and from which the absorption-ready gaseous material 112 is derived. In some embodiments, for example, it is desirable to reclaim this energy, such as, for example, by heating the cooler desorption-stimulating heating fluid.

In this respect, in some embodiments, for example, the processing of a gaseous effluent derivative material flow 12A includes a supplying of a gaseous effluent material input 24A, derived from the cooler gaseous material supply 24, to the prime mover 20, and an imparting of energy to the gaseous effluent material input 24A, by the prime mover 20, with effect that the gaseous effluent material output 26 is produced and discharged from the prime mover 20. The imparting of energy includes, amongst other things (such as, for example, in addition to imparting of kinetic energy to the gaseous effluent material input 24A), a heating of the gaseous effluent material input 24A by the prime mover 20. In this respect, the processing of the gaseous effluent material derivative flow includes imparting energy to the gaseous effluent material input 24A (derived from the gaseous effluent material 12) with the prime mover 20, wherein the imparting energy includes heating the gaseous effluent material input 24A such that the temperature of the gaseous effluent material output 26 is greater than the temperature of the gaseous effluent material input 24A. In some embodiments, for example, the heating is with effect that the temperature of the gaseous effluent material output 26 is greater than the temperature of the gaseous effluent material input 24A by at least one degree Fahrenheit. In some embodiments, for example, the heating is with effect that the temperature of the gaseous effluent material output 26 is greater than the temperature of the gaseous effluent material input 24A by a temperature differential, and the temperature differential is at least 30 degrees Fahrenheit, such as, for example, a temperature differential that is within a range, and the range is from 30 degrees Fahrenheit to 80 degrees Fahrenheit. In some embodiments, for example, the heating is with effect that the temperature of the gaseous effluent material output 26 is at least 300 degrees Fahrenheit In some embodiments, for example, the heating is with effect that the temperature of the gaseous effluent material output 26 is less than 550 degrees Fahrenheit In some embodiments, for example, the heating is with effect that the temperature of the gaseous effluent material output 26 is within a range, and the range is from 375 degrees Fahrenheit to 450 degrees Fahrenheit.

To mitigate the increase in temperature of the gaseous effluent material output 26 that is attributable to the heat energy imparted by the prime mover 20, and thereby mitigate the adverse effects on the absorption of the absorbed pollutant material that such temperature increase would have, in some embodiments, for example, the cooling of the absorption-resisting gaseous material 18 includes a cooling of a hot intermediate gaseous effluent material 26A (derived from the gaseous effluent material output 26), with effect that a cooler intermediate gaseous effluent material 28 is produced, such that the absorption-ready gaseous material 112 derives from the cooler intermediate gaseous effluent material 28 (and, in some embodiments, for example, the absorption-ready gaseous material 112 is the cooler intermediate gaseous effluent material 28). The temperature of the cooler intermediate gaseous effluent material 28 is less than the temperature of the hot intermediate gaseous effluent material 26A. In this respect, in some embodiments, for example, the cooling, of the hot intermediate gaseous effluent material 26A, is with effect that the temperature of the cooler intermediate gaseous effluent material 28 is lower than the temperature of the hot intermediate gaseous effluent material 26A by at least one degree Fahrenheit, such as, for example, by a temperature differential that is at least from 10 degrees Fahrenheit, such as, for example, at least 50 degrees Fahrenheit, such as, for example, at least 100 degrees Fahrenheit, such as, for example, at least 150 degrees Fahrenheit. In some embodiments, for example, the temperature of the cooler intermediate gaseous effluent material 28 is below 400 degrees Fahrenheit. In some embodiments, for example, the temperature of the cooler intermediate gaseous effluent material 28 is above 250 degrees Fahrenheit. In some embodiments, for example, the temperature of the cooler intermediate gaseous effluent material 28 is within a range, and the range is from 250 degrees Fahrenheit to 350 degrees Fahrenheit

In some embodiments, for example, the cooling of the hot intermediate gaseous effluent material 26A is effected via the discharge side waste heat recovery subsystem 330. In some embodiments, for example, the cooling of the hot intermediate gaseous effluent material 26A, via the discharge side waste heat recovery (“WHR”) system 330, is effected in response to emplacement of the hot intermediate gaseous effluent material 26A in heat transfer communication (e.g. indirect heat transfer communication) with a discharge side cool WHR cooling fluid 344, such that, correspondingly, the discharge side cool WHR cooling fluid 344 is heated, and with effect that the discharge side heated WHR cooling fluid 346 is produced. In this respect, the cooling of the absorption-resisting gaseous material 18, by the cooler desorption-stimulating heating fluid, includes the cooling of the hot intermediate gaseous effluent material 26A by the discharge side cool WHR cooling fluid 344. Also in this respect, the temperature of the hot intermediate gaseous effluent material 26A is greater than the temperature of the discharge side cool WHR cooling fluid 344. In some embodiments, for example, the temperature of the hot intermediate gaseous effluent material 26A exceeds the temperature of the discharge side cool WHR cooling fluid 344 by at least one (1) degree Fahrenheit. In some embodiments, for example, the temperature of the hot intermediate gaseous effluent material 26A exceeds the temperature of the discharge side cool WHR cooling fluid 344 by a temperature differential of at least ten (10) degrees Fahrenheit, such as, for example, at least 30 degrees Fahrenheit, such as, for example, at least 50 degrees Fahrenheit. In some embodiments, for example, the discharge side heated WHR cooling fluid 346, obtained as a result of the heating of the discharge side cool WHR cooling fluid 344, has a temperature that exceeds the temperature of the discharge side cool WHR cooling fluid 344 by at least 5 degrees Fahrenheit, such as, for example, at least 10 degrees Fahrenheit.

In some embodiments, for example, the recovered post-desorption heating fluid 340 is recycled such that the hot desorption-stimulating fluid 354 includes the recovered post-desorption heating fluid 354 (and, in some embodiments, for example, the hot desorption-stimulating fluid 354 is the recovered post-desorption heating fluid 340). The recycling includes processing of a recycling heating fluid that is derived from the recovered post-desorption heating fluid 340. The processing of the recycling heating fluid includes the cooling of the absorption-resisting gaseous material 18 by the cooler desorption-stimulating heating fluid 342, such that the cooler desorption-stimulating heating fluid 342 is derived from the recovered post-desorption heating fluid 340 (and, in some embodiments, for example, the cooler desorption-stimulating heating fluid 342 is the recovered post-desorption heating fluid 340).

As explained above, in some embodiments, for example, the cooling of the absorption-resisting gaseous material 18 by the cooler desorption-stimulating heating fluid 342 includes the cooling of the hot gaseous material supply 22 effected via the suction side waste heat recovery subsystem 320, and also includes the cooling of the hot intermediate gaseous effluent material 26A effected via the discharge side waste heat recovery subsystem 330. In this respect, in some embodiments, for example, the processing of a recycling heating fluid includes the cooling of the hot gaseous material supply 22 effected via the suction side waste heat recovery subsystem 320, and the cooling of the hot intermediate gaseous effluent material 26A effected via the discharge side waste heat recovery subsystem 330, such that the discharge side cool WHR cooling fluid 344 is derived from the recovered post-desorption heating fluid 340 (and, in some embodiments, for example, the discharge side cool WHR cooling fluid 344 is the recovered post-desorption heating fluid 340).

In some embodiments, for example, despite the cooling of the hot intermediate gaseous effluent material 26A, the temperature of the cooler intermediate gaseous effluent material 28 is still excessively high, and can adversely affect the absorption of the absorbed pollutant material, but is not sufficiently high to justify its recovery. In this respect, in some embodiments, for example, the cooling of the absorption-resisting gaseous material 18 includes a cooling of an absorption-unsuitable gaseous material 28A, that is derived from the cooler intermediate gaseous effluent material 28 (and, in some embodiments, for example, the cooler motivated downstream gaseous material derivative 28A is the cooler intermediate gaseous effluent material 28). The cooling of the absorption-unsuitable gaseous material 28A is with effect that a further cooled gaseous material 30 is produced, such that the absorption-ready gaseous material 112 derives from the further cooled gaseous material 30 (and, in some embodiments, for example, the absorption-ready gaseous material 112 is the further cooled gaseous material 30). The temperature of the further cooled gaseous material 30 is below the temperature of the absorption-unsuitable gaseous material 28A. In some embodiments, for example, the cooling, of the absorption-unsuitable gaseous material 28A, is with effect that the temperature of the further cooled gaseous material 30 is lower than the temperature of the absorption-unsuitable gaseous material 28A by at least one degree Fahrenheit. In some embodiments, for example, the temperature of the further cooled gaseous material 30 is lower than the temperature of the absorption-unsuitable gaseous material 28A by a temperature differential that is from 100 degrees Fahrenheit to 125 degrees Fahrenheit. In some embodiments, for example, the temperature of the further cooled gaseous material 30 is below 125 degrees Fahrenheit.

In some embodiments, for example, the cooling of the absorption-unsuitable gaseous material 28A is effected via direct contact cooling within a direct contact cooling zone 130. In this respect, in some embodiments, for example, the cooling of the absorption-unsuitable gaseous material 28A is effected via contacting the absorption-unsuitable gaseous material 28A with liquid cooling material 134. The contacting is with effect that the further cooled gaseous material 30 is produced. In some embodiments, for example, the liquid cooling material 134 is an aqueous material, such as, for example, liquid water. In some embodiments, for example, the liquid cooling material 134 is in the form of liquid droplets. In some embodiments, for example, the process further includes spraying the liquid cooling material 134 into the direct contact cooling zone 130, such that the contacting, of the absorption-unsuitable gaseous material 28A with the liquid cooling material 134, includes that effected by the spraying. In some embodiments, for example, the contacting between the absorption-unsuitable gaseous material 28A with liquid cooling material 134 is effected via contacting-effective media. Suitable examples of contacting-effective media include moveable valve trays, non-moveable valve trays, sieve trays, bubble cap trays, random packing, and structured packing.

In some embodiments, for example, the direct contact cooling zone 130 is disposed within the gaseous effluent treating vessel 100, such that the gaseous effluent treating vessel 100, in addition to defining the absorption zone 110, also defined the direct contact cooling zone 130. In some embodiments, for example, the direct contact cooling zone 130 defines a cross-sectional flow area of at least 1.75 square feet, such as, for example, at least 4.5 square feet, such as, for example, at least 6.5 square feet, and the absorption zone 110 defines a cross-sectional flow area of at least 1.75 square feet, such as, for example, at least 4.5 square feet, such as, for example, at least 6.5 square feet.

In some embodiments, for example, similarly, the direct contact cooling zone 130 is also occupied by contacting-effective media for encouraging the contacting of the absorption-unsuitable gaseous material 28A with liquid cooling material 134. Suitable examples of contacting-effective media include moveable valve trays, non-moveable valve trays, sieve trays, bubble cap trays, random packing, and structured packing.

FIG. 2 illustrates a system 8A, which is similar to the system 8 illustrated in FIG. 1. However, unlike the prime mover 20 of system 8, the prime mover 20 of system 8A is disposed downstream of the gaseous effluent treating vessel 100 (which defines the absorption zone 110 and the direct contact cooling zone 130) for inducing flow of the gaseous effluent derivative material flow 12A via at least the waste heat recovery subsystem 310 and the gaseous effluent treating vessel 100. By emplacing the prime mover 20 downstream of the gaseous effluent treating vessel 100 in system 8A, heat, being added to the gaseous effluent derivative material flow 12A upstream of the absorption zone 110, is avoided, such that, unlike the system 8, management of such added incremental heat, for mitigating the adverse effects on the absorption of the absorbed pollutant material that of the corresponding temperature increase, is also avoided, such that emplacement of an additional waste heat energy subsystem is not necessary.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

1. A method of treating a gaseous effluent material that includes pollutant material, comprising:
within a process vessel, processing a gaseous effluent-derived material, that is derived from the gaseous effluent material, with effect that at least a pollutant material-lean gaseous material product is produced;
wherein:
the processing of the gaseous effluent-derived material includes:
within a direct contact cooling zone, defined within the process vessel, contacting an absorption-unsuitable gaseous material with liquid cooling material, with effect that at least a cooled gaseous material is produced, wherein the absorption-unsuitable gaseous material is derived from the gaseous effluent material; and
within an absorption zone, defined within the process vessel, contacting an absorption-ready gaseous material, derived from the cooled gaseous material, with an absorption-effective material, with effect that at least a portion of the pollutant material, of the absorption-ready gaseous material, is absorbed by the absorption-effective material, such that at least a pollutant material-depleted gaseous material and a loaded absorbent-comprising material are produced;
and
the pollutant material-lean gaseous material product is derived from the pollutant material-depleted gaseous material.

2. (canceled)

3. (canceled)

4. The process as claimed in claim 1;
wherein:
the pollutant material includes an acid gas.

5. (canceled)

6. (canceled)

7. The process as claimed in claim 1;
wherein:
the absorption-effective material is an amine-based material.

8. (canceled)

9. (canceled)

10. (canceled)

11. (canceled)

12. (canceled)

13. (canceled)

14. The process as claimed in claim 1;
wherein:
the absorption-effective material is an amine-based material.

15. (canceled)

16. The process as claimed in claim 1;
wherein:
the direct contact cooling zone has a cross-sectional flow area of at least 1.75 square feet; and
the absorption zone has a cross-sectional flow area of at least 1.75 square feet.

17. A method of treating a gaseous effluent material that includes pollutant material, comprising:
establishing a gaseous effluent derivative material flow, that is derived from the gaseous effluent material and is motivated by a prime mover;
processing the gaseous effluent derivative material flow via a process configuration that is disposed downstream of the prime mover, wherein:
the processing of the gaseous effluent material flow is with effect that at least a pollutant material-lean gaseous product and a pollutant material-rich absorbent-comprising material product are produced;
the processing of the gaseous effluent derivative material flow includes:
cooling an absorption-resisting gaseous material, derived from the gaseous effluent material, with effect that a cooled gaseous effluent derivative material is produced; and
contacting an absorption-ready gaseous material, that is derived from the cooled gaseous effluent derivative material, with an absorption-effective material, with effect that at least a portion of the pollutant material, of the absorption-ready gaseous material, is absorbed by the absorption-effective material, such that at least a pollutant material-depleted gaseous material and a loaded absorbent-comprising material are produced;
the pollutant material-lean gaseous product stream is derived from the pollutant material-depleted gaseous material;
and
the pollutant material-rich absorbent-comprising material product is derived from the loaded absorbent-comprising material;
and
heating the pollutant material-rich absorbent-comprising material product, with effect that a pollutant material-rich gaseous material is released from the pollutant material-rich absorbent-comprising material;
wherein:
the cooling, of the absorption-resisting gaseous material, co-operates with the heating of the pollutant material-rich absorbent-comprising material product, such that the heating, of the pollutant material-rich absorbent-comprising material product, includes heating effected by energy recovered from the cooling of the hot gaseous effluent material.

18. The process as claimed in claim 17;
wherein:
the cooling, of the absorption-resisting gaseous material, includes emplacing the absorption-resisting gaseous material in heat transfer communication with a cooler desorption-stimulating heating fluid, with effect that the cooler desorption-stimulating heating fluid is heated, such that a gaseous effluent-heated desorption-stimulating heating fluid is obtained; and
the heating, of the pollutant material-rich absorbent-comprising material product, includes emplacing the pollutant material-rich absorbent-comprising material product in heat transfer communication with a hot desorption-stimulating heating fluid that is derived from the gaseous effluent-heated desorption-stimulating heating fluid;
such that the co-operation between the cooling and the heating is established.

19. The process as claimed in claim 18;
wherein:
the temperature of the absorption-resisting gaseous material exceeds the temperature of the cooler desorption-stimulating heating fluid by at least 30 degrees Fahrenheit.

20. The process as claimed in claim 17;
wherein:
the temperature of the absorption-resisting gaseous material is at least 300 degrees Fahrenheit.

21. (canceled)

22. The method as claimed in claim 17;
wherein:
the heating, of the pollutant material-rich absorbent-comprising material product, is with effect that the hot desorption-stimulating heating fluid is cooled such that a recovered post-desorption heating fluid is obtained; and
further comprising:
recycling the recovered post-desorption heating fluid such that the hot desorption-stimulating fluid includes the recovered post-desorption heating fluid wherein:
the recycling includes processing of a recycling heating fluid that is derived from the recovered post-desorption heating fluid; and
the processing of the recycling heating fluid includes the cooling of the absorption-resisting gaseous material by the cooler desorption-stimulating heating fluid, such that the cooler desorption-stimulating heating fluid is derived from the recovered post-desorption heating fluid.

23. The method as claimed in claim 22;
wherein:
the cooling of the absorption-resisting gaseous material by the cooler desorption-stimulating heating fluid includes cooling of a hot intermediate gaseous effluent material that is derived from the gaseous effluent material and discharged by the prime mover.

24. The method as claimed in claim 23;
wherein:
the temperature of the hot intermediate gaseous effluent material exceeds the temperature of the cooler desorption-stimulating heating fluid by at least 30 degrees Fahrenheit.

25. The process as claimed in claim 23;
wherein:
as a corollary to the establishment of a gaseous effluent derivative material flow, the prime mover is receiving a gaseous effluent material input, that is derived from the gaseous effluent material, and discharging a gaseous effluent material output that is derived from the gaseous effluent material input;
the hot intermediate gaseous effluent material is derived from the gaseous effluent material output; and
the temperature of the gaseous effluent material output is greater than the temperature of the gaseous effluent material input by at least 30 degree Fahrenheit.

26. The process as claimed in claim 25;
wherein:
the temperature of the gaseous effluent material input is at least 275 degrees Fahrenheit.

27. The process as claimed in claim 25;
wherein:
the gaseous effluent material has a temperature of at least 500 degrees Fahrenheit
further comprising:
cooling the gaseous effluent material such that the gaseous effluent material input is obtained.

28. (canceled)

29. The process as claimed in claim 17;
wherein:
the pollutant material includes an acid gas.

30. (canceled)

31. (canceled)

32. The process as claimed in claim 17;
wherein:
the absorption-effective material is an amine-based material.

33. (canceled)

34. A method of treating gaseous effluent material that includes pollutant material, comprising:
via at least a prime mover, establishing a gaseous effluent material flow that is derived from the gaseous effluent material; and
processing the gaseous effluent material flow via a process configuration with effect that at least a pollutant material-lean gaseous material product is produced, wherein:
the processing of the gaseous effluent material flow includes, within an absorption zone of the process configuration, contacting an absorption-ready gaseous material flow, that is derived from the gaseous effluent material, with an absorption-effective material with effect that at least a portion of the pollutant material, of the absorption-ready gaseous material, is absorbed by the absorption-effective material, such that at least a pollutant material-depleted gaseous material is produced;
wherein:
the pollutant material-lean gaseous material product is derived from the pollutant material-depleted gaseous material; and
the absorption zone is disposed upstream of the prime mover.

35. (canceled)

36. (canceled)

37. The process as claimed in claim 34;
wherein:
the pollutant material includes an acid gas.

38. (canceled)

39. (canceled)

40. The process as claimed in claim 34;
wherein:
the absorption-effective material is an amine-based material.

41. (canceled)

42. (canceled)

43. (canceled)

44. The process as claimed in claim 41;
wherein:
the absorption-effective material is an amine-based material.

45. (canceled)
